(19) United States
(12) Patent Application Publication
(10) Pub. No.: US 2006/0077991 A1
(43) Pub. Date: Apr. 13, 2006

(54) Transmission apparatus and transmission system

(76) Inventor: Masashige Kawarai, Kawasaki (JP)

Correspondence Address: KATTEN MUCHIN ROSENMAN LLP, 575 MADISON AVENUE, NEW YORK, NY, 10022-2585, US

(21) Appl. No.: 11/287,812

(22) Filed: Nov. 28, 2005

Related U.S. Application Data
(63) Continuation of application No. PCT/JP03/10431, filed on Aug. 19, 2003.

(51) Int. Cl. H04L 12/28

(52) U.S. Cl. 370/403

(57) ABSTRACT

Switching control apparatus and method between LAN interface terminals that are accommodated in a ring network including a synchronous network. A transmission system which is capable of performing high-speed redundant switching in the event of a failure of a transmission path regardless of the number of rings in a multi-ring configuration includes a first transmission apparatus connected to a first terminal has a LAN interface for sending and receiving an ordinary packet, and a synchronous frame interface for sending and receiving a synchronous frame to and from a second transmission path, a link detector for detecting a physical link failure of the first transmission path. The system also includes a second transmission apparatus connected to the first transmission apparatus and also connected to a second terminal. The second transmission apparatus has a synchronous frame interface for sending and receiving a synchronous frame.

This is a continuation of PCT International Application No. PCT/JP03/10431, filed Aug. 19, 2003, which was not published in English.

### BACKGROUND OF THE INVENTION

1. Field of the Invention

The present invention relates to switching control for a transmission apparatus and a transmission system, and more particularly to switching control between LAN interface terminals that are accommodated in a ring network including a synchronous network.

2. Description of the Related Art

In recent years, transmission systems for transmitting data through Ethernet networks have been required to perform high-quality, highly reliable transmission. Ring networks are constructed of a plurality of transmission apparatus accommodating synchronous networks such as Ethernet networks and SDH (Synchronous Digital Hierarchy)/SONET (Synchronous Optical NETwork), and etherpackets are accommodated in synchronous frames for high-speed, highly reliable, high-quality transmission. Transmission apparatus having SDH/SONET interfaces and making up ring networks (ring-type transmission apparatus) are arranged to perform high-speed redundant switching, e.g., UPSR switching in 50 ms, for example, in the event of a failure of a transmission path interconnecting synchronous networks of transmission apparatus (a failure of a transmission path between transmission apparatus).

In ring-type transmission apparatus for accommodating Ethernet networks and transmitting data through the Ethernet networks, there is a pressing need to realize the same high-speed redundant switching performance as upon a failure of a transmission path between transmission apparatus, in the event of a link failure caused when a transmission path connecting an Ethernet network between a terminal such as a router and a transmission apparatus. At present, a transmission path between a terminal and a transmission apparatus has a redundant configuration, and a redundant switching function for a ring-type Ethernet network serving as a ring network made up of a plurality of transmission apparatus is provided by the terminal, e.g., a router. Most processes for interoffice transmission between terminals are performed by a network configuration wherein packets are accommodated in backbone frames, e.g., SDH/SONET frames, and transmitted and relayed. Usually, the redundant switching condition to be satisfied at terminals is a link failure (a failure at layer 1), and backbone-supporting transmission apparatus need a function to detect a transmission path failure and transfer a link failure between terminals. This concept is referred to as a link pass-through process.

FIG. 9 is a diagram showing a transmission system. In the illustrated example, the transmission system has rings in multiple stages, e.g., the number of rings is 2. Each of transmission apparatus 2#i (i=1, . . . ) accommodates an ether interface and an SDH interface. Transmission apparatus 2#1, 2#2 and transmission paths 12W#1, 12P#1 of redundant configuration which interconnect the transmission apparatus 2#1, 2#2 make up a ring network (ring 1) of an active system, and transmission apparatus 2#3, 2#4 and transmission paths 12W#2, 12P#2 of redundant configuration which interconnect the transmission apparatus 2#3, 2#4 make up a ring network (ring 2) of the active system. Transmission apparatus 2#5, 2#6 and transmission paths 12W#3, 12P#3 of redundant configuration which interconnect the transmission apparatus 2#5, 2#6 make up a ring network (ring 1) of an inactive system, and transmission apparatus 2#7, 2#8 and transmission paths 12W#4, 12P#4 of redundant configuration which interconnect the transmission apparatus 2#7, 2#8 make up a ring network (ring 2) of the inactive system. A terminal 20#1 is connected to transmission apparatus 2#1 by an active system transmission path 14W#1, and is connected to transmission apparatus 2#5 by an inactive system transmission path 14P#1. A terminal 20#2 is connected to transmission apparatus 2#4 by an active system transmission path 14W#2, and is connected to transmission apparatus 2#8 by an inactive system transmission path 14P#2. The rings 1, 2 are connected to each other by transmission paths 16W#1, 16P#1.

FIG. 10 is a diagram showing an example of structural details of transmission apparatus shown in FIG. 9. FIG. 10 shows an example of structural details of transmission apparatus 2#1, 2#2. As shown in FIG. 10, the transmission apparatus 2#i has an Ethernet INF unit 4#i, an Ethernet/SDH converter 6#i, a cross-connect function unit 7#i, an SDH INF unit 8#i, a link detector 50#i, and an L byte inserter 52#i.

In this transmission system, when the terminal 20#1 shown in FIG. 9 sends a packet from an ether interface 30W#1 toward the terminal 20#2, the Ethernet INF unit 4#1 of the transmission apparatus 2#1 receives the packet from the transmission path 14#1, as shown in FIG. 10. The Ethernet/SDH converter 6#1 accommodates the etherpacket in an SDH frame. The cross-connect function unit 7#1 cross-connects the SDH frame to an active system SDH INF unit 54W#1. The active system SDH INF unit 54W#1 sends the SDH frame to the transmission path 12W#1.

When an active system SDH INF unit 54#2 of the transmission apparatus 2#2 receives the SDH frame from the transmission path 12W#1, the cross-connect function unit 7#2 inputs the SDH frame from the active system SDH INF unit 54#2, and outputs the SDH frame to the Ethernet/SDH converter 6#2. The Ethernet/SDH converter 6#2 assembles the etherpacket from the SDH frame. The Ethernet INF unit 4#2 sends the etherpacket to the transmission path 16W#1.

When the transmission apparatus 2#3 of the ring 2 receives the etherpacket from the transmission path 16W#1, it accommodates the etherpacket in an SDH frame, and sends the SDH frame to the transmission path 12#2. When the transmission apparatus 2#4 receives the SDH frame from the transmission path 12W#2, it assembles the etherpacket from the SDH frame, and sends the etherpacket to the transmission path 14#2.

An ether interface 30W#2 of the terminal 20#2 receives the etherpacket from the transmission path 14#2. If the terminal 20#2 is a router, for example, then it routes the etherpacket according to the IP address thereof. When an SDH network transmission path fails, e.g., when the transmission path 12W#1 fails, it switches to the transmission path 12P#1 according to a switching process such as UPSR.

FIG. 11 is a diagram showing a conventional link pass-through process. A link detector 50#1 of the transmission apparatus 2#1 and the terminal 20#1 are monitoring whether the transmission path 14W#1 is normal or not by returning responses to each other according to a given protocol. In the event of a fault of the transmission path 14#1 as indicated at (a) in FIG. 9 and (a) in FIG. 11, the link detector 50#1 of the transmission apparatus 2#1 and the terminal 20#1 detect the fault (a). When the terminal 20#1 detects the fault, it switches to an inactive system ether interface 30P#1, as indicated at (a) in FIG. 9 and (a) in FIG. 11.

FIG. 12 is a flowchart of a process of inserting an L byte. FIG. 13 is a diagram showing an L byte in an SDH frame. FIG. 14 is a flowchart of a process of detecting an L byte. In order to report a link failure to the terminal 20#2 of the associated office, when the link detector 50#1 of the transmission apparatus 2#1 detects the link failure, it notifies the L byte inserter 52#1 of the link failure. The L byte inserter 52#1 determines whether a link break failure is detected or not in step S2 shown in FIG. 12. If a link break failure is detected, then control goes to step S4. If a link break failure is not detected, then control goes to step S6.

If a link break failure is detected, then “000000001” (a link break control bit) representing a link failure is inserted into an L byte area at a given position in the payload of the SDH frame, as shown in FIG. 13. In FIG. 13, RSOH, AU-PTR, MSOH, and POH represent an overhead. If a link break failure is not detected, then “000000000” representing a normal link is inserted into the L byte area. The Ethernet/SDH converter 6#1 sends the SDH frame with the “link break control bit” inserted therein through the cross-connect function unit 7#1 and the active system SDH INF unit 54W#1 to the transmission path 12W#1. When an active system SDH INF unit 54W#2 receives the SDH frame with the “link break control bit” inserted therein, it outputs the SDH frame through the cross-connect function unit 7#2 to an L byte detector 60#2.

The L byte detector 60#2 determines whether the “link break control bit” is “1” or “0” in step S10 shown in FIG. 14. If the “link break control bit” is “1”, then control goes to step S12. If the “link break control bit” is “0”, then the flowchart is ended. In step S12, control waits until a flapping prevention protection time, e.g., 50 ms or more, elapses. If the “link break control bit” is still “1” after the elapse of the flapping prevention protection time, then the L byte detector 60#2 notifies a link break controller 62#2 of a link break. For example, as indicated at (c) in FIG. 11, the transmission apparatus 2#2 waits until a UPSR flapping prevention protection time elapses.

UPSR flapping prevention protection is performed for the following reasons: If switching is made due to an SDH network failure according to UPSR, then since the values of the bits of the SDH frame are indefinite for about 50 ms, it is necessary to determine properly whether the “link break control bit” is ON because of USPR switching or a link break. If the “link break control bit” is ON even after the elapse of the flapping prevention protection time, then it can be determined that the “link break control bit” is ON due to a link break. In step S14, the link break controller 62#2 performs a link break control process according to a given protocol, i.e., notifies the Ethernet network of the link break, as indicated at (d) in FIG. 9 and (d) in FIG. 11.

Similarly, if the transmission apparatus 2#3 is notified of a link break from the transmission apparatus 2#2, then, as with the transmission apparatus 2#1, the transmission apparatus 2#3 turns ON the “link break control bit” in an L byte area, and sends an SDH frame to the transmission apparatus 2#4. When the transmission apparatus 2#4 detects that the “link break control bit” is ON as with the transmission apparatus 2#2, the transmission apparatus 2#4 waits until the UPSR flapping prevention protection time elapses as indicated at (e) in FIG. 11. When the UPSR flapping prevention protection time elapses, the transmission apparatus 2#4 performs a link break control process as indicated at (f) in FIG. 9 and (f) in FIG. 11. When the terminal 20#2 is notified of a link break from the transmission apparatus 2#4, redundancy switching is performed from the active system to the inactive system, as indicated at (g) in FIG. 9 and (g) in FIG. 11. Therefore, a period of time 50 ms×2 (the number of links)=100 ms is consumed after the transmission apparatus 2#1 has detected a link break until the terminal 20#2 performs switching.

Since the conventional link pass-through process is a switching process confined to one ring, the time to transfer a link failure is delayed if more inter-ring connections are involved to provide a multi-ring configuration. For example, if the flapping prevention time is 50 msec., then the time to transfer a link failure is represented by 50 msec.×the number of rings, with the results that it takes some time to perform redundancy switching in the event of a transmission path fault, and high-speed redundancy switching cannot be carried out.

A prior technical document (Japanese Patent Laid-open No. Hei 7-264229) discloses a technology wherein each node of a ring network receives a SONET pass, and when fault information is input, switching is performed between reception terminals thereby to prevent a service interruption in the event of the occurrence of a fault.

However, the above prior technology is concerned with switching control in each NE of the ring network, and does not disclose anything about switching control at Ethernet terminals and is unable to solve the above problems. Furthermore, since failure information is sent by way of a SONET pass, if a link break control process is to be effected on an Ethernet network, it is necessary to perform flapping prevention protection, and no quick switching can be performed between terminals.

### SUMMARY OF THE INVENTION

It is an object of the present invention to provide a transmission system which is capable of performing high-speed redundant switching in the event of a failure of a transmission path regardless of the number of rings in a multi-ring configuration.

According to an aspect of the present invention, there is provided a transmission apparatus including a LAN interface for sending and receiving an ordinary packet to and from a first transmission path according to a LAN interface process, a synchronous frame interface for sending and receiving a synchronous frame to and from a second transmission path, a link detector for detecting a physical link failure of the first transmission path, a first setting information storage unit for storing first setting information for distinguishing between a switching-dedicated packet and an ordinary packet, the first setting information being set in a header of the switching-dedicated packet, a switching-dedicated packet inserter for setting a link pass state indicative of whether the physical link failure is normal or abnormal as detected by the link detector, and the first setting information in the header of the switching-dedicated packet, a packet multiplexer for multiplexing the switching-dedicated packet and the ordinary packet, a packet/synchronous frame converter for accommodating the multiplexed packets in the synchronous frame, and a synchronous frame/packet converter for converting the synchronous frame received by the synchronous frame interface into a packet.

According to another aspect of the present invention, there is provided a transmission system including a first transmission apparatus connected to a first terminal, a second transmission apparatus connected to the first transmission apparatus, a third transmission apparatus connected to the second transmission apparatus, and a fourth transmission apparatus connected to the third transmission apparatus, including LAN interfaces provided respectively in the first through fourth transmission apparatus, for sending and receiving an ordinary packet according to a LAN interface process, synchronous frame interfaces provided respectively in the first through fourth transmission apparatus, for sending and receiving a synchronous frame, a link detector provided in the first transmission apparatus for detecting a physical link failure of a transmission path connected to the first terminal, a first setting information storage unit provided in the first and second transmission apparatus for storing first setting information for distinguishing between a switching-dedicated packet and an ordinary packet, the first setting information being set in a header of the switching-dedicated packet, a switching-dedicated packet inserter provided in the first transmission apparatus for setting a link pass state indicative of whether the physical link failure is normal or abnormal as detected by the link detector, and the first setting information in the header of the switching-dedicated packet, a packet multiplexer provided in the first transmission apparatus for multiplexing the switching-dedicated packet and the ordinary packet, a packet/synchronous frame converter provided in the first transmission apparatus for accommodating the multiplexed packets in the synchronous frame, packet/synchronous frame converters provided in the second through fourth transmission apparatus for accommodating the packet received by the LAN interfaces in the synchronous frame, synchronous frame/packet converters provided in the first through fourth transmission apparatus for converting the synchronous frame received by the synchronous frame interface into a packet, second setting information storage units provided in the second through fourth transmission apparatus for storing second setting information representative of a directly controlled station having a terminal connected to transmission paths to which the LAN interfaces are connected or a relay station having no terminal connected to the transmission paths, switching-dedicated packet detectors provided in the second and third transmission apparatus for comparing the first setting information and a header of the packet converted by the synchronous frame/packet converters with each other to determine whether the packet is a switching-dedicated packet sent from a companion transmission apparatus or not, outputting the ordinary packet to the LAN interfaces, transferring the switching-dedicated packet to the LAN interfaces when a station of its own represents the relay station based on the second setting information, and indicating a link failure when the station of its own represents the directly controlled station based on the second setting information and the link pass state of the switching-dedicated packet represents the link failure, and a link break controller provided in the third transmission apparatus for performing a link break control process based on the link failure indicated by the switching-dedicated packet detectors.

The above and other objects, features, and advantages of the present invention and the manner of realizing them will become more apparent, and the invention itself will best be understood from a study of the following description and appended claims with reference to the attached drawings showing some preferred embodiments of the invention.

### BRIEF DESCRIPTION OF THE DRAWINGS

FIG. 1 is a diagram showing the principles of the present invention;

FIG. 2 is a diagram showing an example of a transmission system according to an embodiment of the present invention;

FIG. 3 is a functional diagram of a transmission apparatus shown in FIG. 2;

FIG. 4 is a diagram showing a dedicated switching packet;

FIG. 5 is a diagram illustrative of operation of the transmission system shown in FIG. 2;

FIG. 6 is a diagram illustrative of operation of the transmission system shown in FIG. 2;

FIG. 7 is a flowchart of an operation sequence for sending a packet;

FIG. 8 is a flowchart of an operation sequence for receiving a packet;

FIG. 9 is a diagram showing an example of a transmission system;

FIG. 10 is a functional diagram of a conventional transmission apparatus;

FIG. 11 is a diagram showing a conventional switching control process;

FIG. 12 is a diagram showing the insertion of an L byte;

FIG. 13 is a diagram showing a synchronous frame including an L byte; and

FIG. 14 is a flowchart of a process of detecting an L byte.

### DETAILED DESCRIPTION OF THE PREFERRED EMBODIMENTS

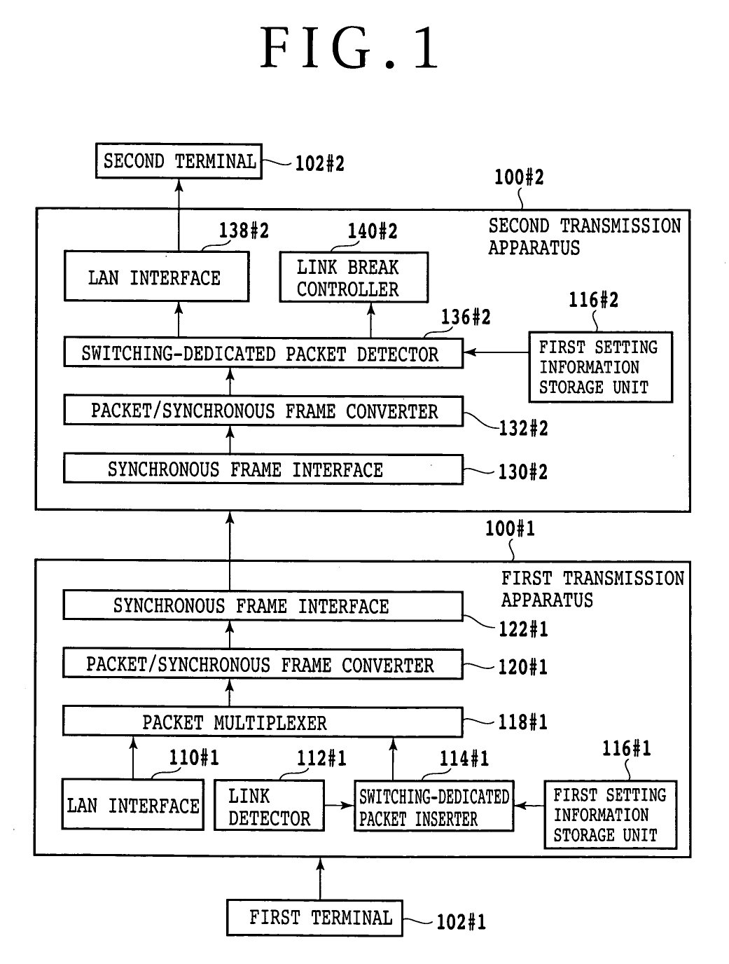

Prior to describing an embodiment of the present invention, the principles of the present invention will be described below. FIG. 1 is a diagram showing the principles of the present invention. As shown in FIG. 1, a transmission system includes a first transmission apparatus 100#1 and a second transmission apparatus 100#2. The first transmission apparatus 100#1 has a LAN interface 110#1, a link detector 112#1, a switching-dedicated packet inserter 114#1, a first setting information storage unit 116#1, a packet multiplexer 118#1, a packet/synchronous frame converter 120#1, and a synchronous frame interface 122#1. The second transmission apparatus 100#2 has a synchronous frame interface 130#2, a packet/synchronous frame converter 132#2, a first setting information storage unit 116#2, a switching-dedicated packet detector 136#2, a LAN interface 138#2, and a link break controller 140#2.

The LAN interface 110#1 is connected to a first terminal 102#1, and receives a LAN packet sent from the first terminal 102#1. The link detector 112#1 detects a link break in a transmission path to which the LAN interface 110#1 is connected. The first setting information storage unit 116#1 stores first setting information for distinguishing between a switching-dedicated packet and an ordinary packet. The switching-dedicated packet inserter 114#1 sets a link pass state indicative of whether there is a link break or not and first setting information, in a switching-dedicated packet. The packet multiplexer 118#1 multiplexes the switching-dedicated packet and the ordinary packet. The packet/synchronous frame converter 120#1 accommodates the packets multiplexed by the packet multiplexer 118#1 in a synchronous frame. The synchronous frame interface 122#1 sends the synchronous frame.

The synchronous frame interface 130#2 receives the synchronous frame. The packet/synchronous frame converter 132#2 removes a packet accommodated in the synchronous frame. The switching-dedicated packet detector 136#2 compares the received packet converted by the packet/synchronous frame converter 132#2 with first setting information stored in the first setting information storage unit 116#2 to determine whether the received packet is a switching-dedicated packet or not. If the received packet is an ordinary packet, then the switching-dedicated packet detector 136#2 outputs the received packet to the LAN interface 138#2. If the received packet is a switching-dedicated packet and link pass information of the switching-dedicated packet indicates a link break, then the switching-dedicated packet detector 136#2 notifies the link break controller 140#2 of the link break.

The LAN interface 138#2 is connected to a second terminal 102#2, and receives an ordinary packet from the switching-dedicated packet detector 136#2 and sends the ordinary packet to the second terminal 102#2. When the link break controller 140#2 is notified of a link break from the switching-dedicated packet detector 136#2, the link break controller 140#2 performs a link break control process on the second terminal 102#2. At this time, since the switching-dedicated packet is used to notify the link break controller 140#2 of a link state, the link break controller 140#2 can perform the link break control process without waiting for a flapping prevention protection time to elapse. Therefore, high-speed switching can be performed on the terminal 102#2. Furthermore, because an L byte in the synchronous frame is not used fixedly, the bandwidth used for a switching-dedicated packet is effectively reduced.

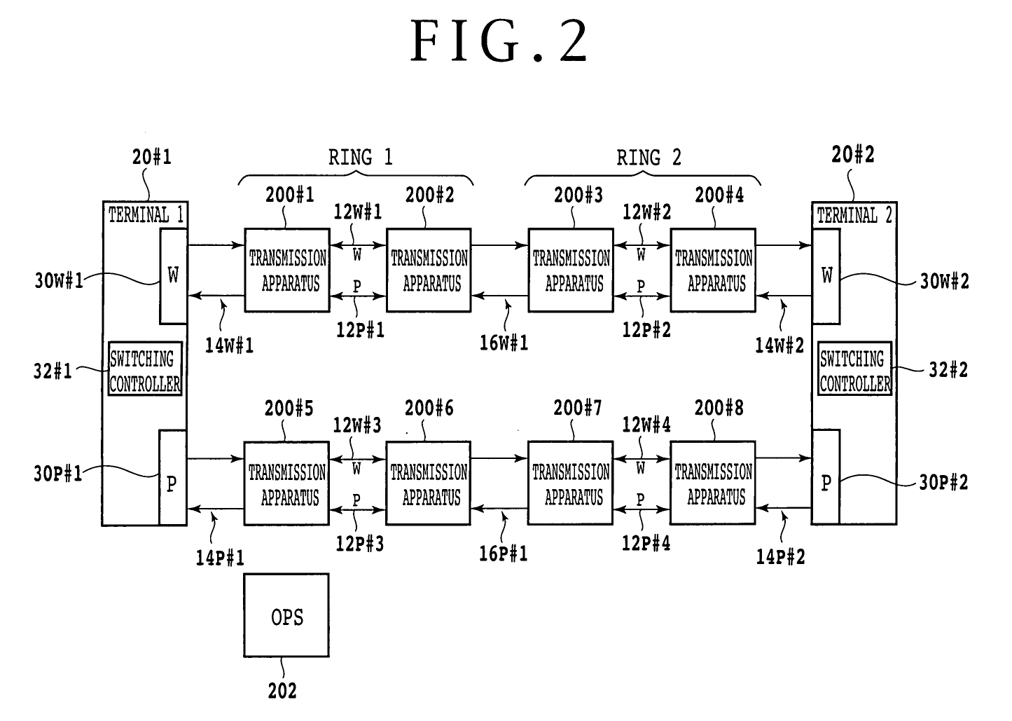

FIG. 2 is a diagram showing a transmission system according to an embodiment of the present invention. As shown in FIG. 2, the transmission system includes eight transmission apparatus 200#i (i=1, . . . , 8) disposed between terminals 20#1, 20#2 and an OPS (Operation System) 202. The terminals 20#i (i=1, 2) are routers or the like, and have transmission paths 14W#i, 14P#i (i=1, 2) and Ethernet interfaces 30W#i, 30P#i (i=1, 2), which are of a redundant configuration, for connection to an Ethernet network. The terminals 20#i have switching controllers 32#i for performing a switching control process for switching from an active system 30W#1, 14W#i to an inactive system 30P#i, 14P#i. If the terminals 20#i are routers, then they also have an interface with a personal computer or the like because they are arranged for connection to the personal computer or the like.

A link break is detected and indicated according to a given Ethernet protocol. Transmission apparatus 200#1, 200#2 and transmission paths 12W#1, 12P#1 make up a ring 1 of the active system. Transmission apparatus 200#3, 200#4 and transmission paths 12W#2, 12P#2 make up a ring 2 of the active system. Transmission apparatus 200#5, 200#6 and transmission paths 12W#3, 12P#3 make up a ring 1 of the inactive system. Transmission apparatus 200#7, 200#8 and transmission paths 12W#4, 12P#4 make up a ring 2 of the inactive system. According to the present embodiment, the network includes two rings, i.e., the ring 1 and the ring 2. However, the network may have a single ring or three or more rings. An ADM device for adding/dropping an SDH frame may be provided in the rings 1, 2. The OPS 202 is a monitoring control terminal for setting first setting information in the transmission apparatus 200#1, 200#5, 200#4, 200#8 and setting second setting information in the transmission apparatus 200#1 through 200#8.

The OPS 202 and the transmission apparatus 200#i (i=1, . . . , 8) may be interconnected by a LAN or a WAN. Alternatively, the transmission apparatus 200#1 may be connected to the OPS 202, and the OPS 202 and the other transmission apparatus 200#2 through 200#8 may communicate with each other by accommodating a setting information notification packet in an SDH overhead and sending it through the transmission apparatus 200#1.

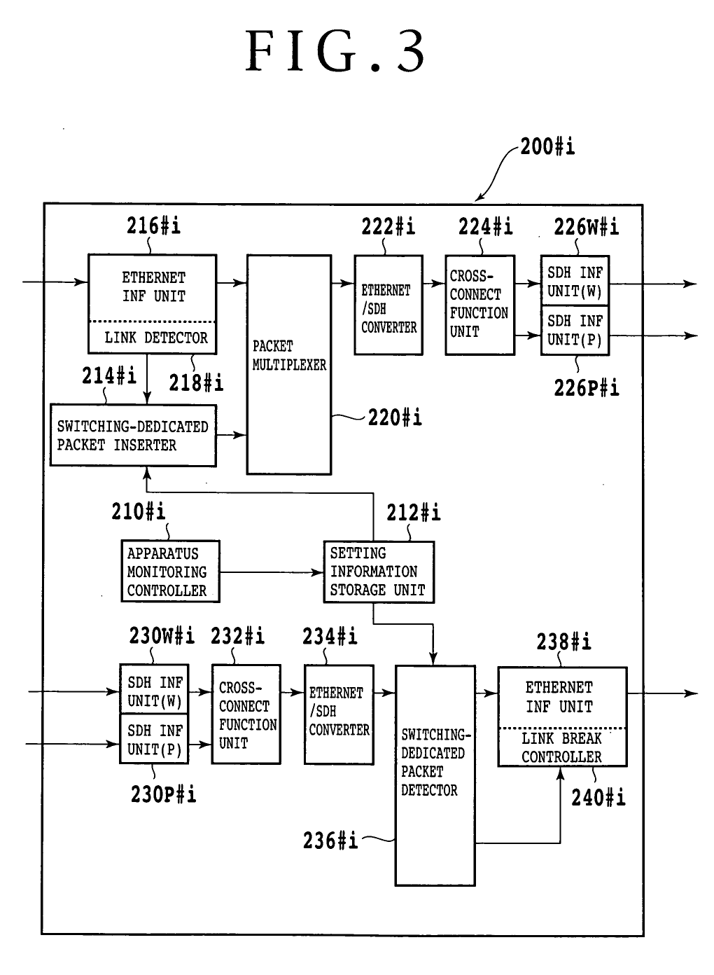

FIG. 3 is a diagram showing the arrangement of the transmission apparatus 200#i shown in FIG. 2. The transmission apparatus 200#i has an apparatus monitoring controller 210#i, a setting information storage unit 212#i, a switching-dedicated packet inserter 214#i, an Ethernet INF unit 216#i, a link detector 218#i, a packet multiplexer 220#i, an Ethernet/SDH converter 222#i, a cross-connect function unit 224#i, SDH INF units 226W#i, 226P#i, SDH INF units 230W#i, 230P#i, a cross-connect function unit 232#i, an SDH/Ethernet converter 234#i, a switching-dedicated packet detector 236#i, an Ethernet INF unit 238#i, and a link break controller 240#i.

The apparatus monitoring controller 210#i has the following functions:

(1) The apparatus monitoring controller 210#i writes first setting information input by the operator, which is to be set in a switching-dedicated packet to be described later, in the setting information storage unit 212#i. The first setting information represents information for distinguishing between a switching-dedicated packet and a packet (ordinary packet) received from an Ethernet network which accommodates the terminals 20#1, 20#2. For example, the first setting information represents information wherein a value of total bytes composed of a source address (SA), a destination address (DA), and a type is different from a value of total bytes composed of those of any ordinary packets. The total bytes composed of the SA, the DA, and the type will hereinafter be referred to as a network address.

The first setting information is set in a transmission apparatus which generates a switching-dedicated packet and a transmission apparatus which terminates a switching-dedicated packet so that it will not be sent to the terminals 20#1, 20#2. The first setting information is set in the transmission apparatus 200#1 through 200#8. The first setting information is set in the transmission apparatus 200#1, 200#4, 200#5, 200#8 in order to generate and terminate a switching packet. The first setting information is set in the transmission apparatus 200#2, 200#3, 200#6, 200#7 in order to monitor a link break and generate a switching-dedicated packet. In the embodiment, the first setting information is set in the transmission apparatus 200#4 through 200#8 in order to monitor a link break in the transmission paths 14P#1, 14#2, 16#1 of the inactive system and generate a switching-dedicated packet after the active system has switched to the inactive system.

(2) The apparatus monitoring controller 210#i writes second setting information input by the operator, which represents whether the station of its own is a relay station for relaying a switching-dedicated packet or a directly controlled station for performing a link break control process according to a switching-dedicated packet, in the setting information storage unit 212#i. The transmission apparatus 200#1, 200#4, 200#5, 200#8 are set as directly controlled stations, and the transmission apparatus 200#2, 200#3, 200#6, 200#7 as relay stations.

The setting information storage unit 212#i is a memory for storing the first and second setting information. The switching-dedicated packet inserter 214#i generates a switching-dedicated packet according to the first setting information and a link state detected by the link detector 218#i. switching-dedicated packet inserter 214#i may generate a switching-dedicated packet at constant cyclic periods, or may generate a switching-dedicated packet when a link break is detected or while a link break is continuing, i.e., only when a link state is abnormal.

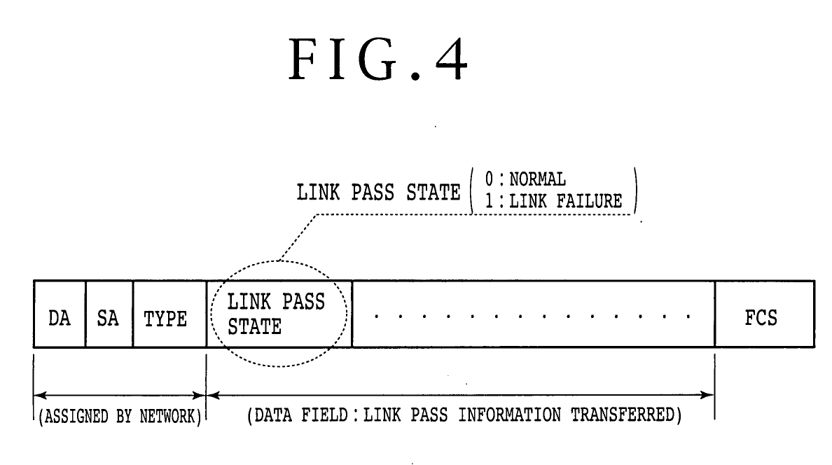

FIG. 4 is a diagram showing a switching-dedicated packet. As shown in FIG. 4, the switching-dedicated packet includes a DA, a SA, and a type which are uniquely assigned by the network according to the first setting information, and a data field in which link pass information is set. The link pass information represents information about a link pass, and includes a link pass state. The link pass state represents a state indicative of whether the transmission paths 14W#1, 14W#2 connected to the terminals 20#1, 20#2 are normal or abnormal. If they are normal, then the link pass state is set to “0”. If they suffer a link failure, then the link pass state is set to “1”. Other link pass information may include information for identifying a transmission path suffering a link failure. According to the present embodiment, the transmission apparatus 200#i is arranged to accommodate a single Ethernet INF unit. However, a transmission apparatus may be arranged to accommodate a plurality of Ethernet INF units. With such an arrangement, when a link break occurs, since there are a plurality of Ethernet INF units, it is necessary to indicate, to a directly controlled station, which one of the Ethernet INF units the terminal to be notified of the link break is connected to.

The Ethernet INF unit 216#i receives an etherpacket and outputs the etherpacket to the packet multiplexer 220#i. The link detector 218#1 detects a link break in the transmission path according to a given protocol, and notifies the switching-dedicated packet inserter 214#i of the link break. The packet multiplexer 220#i multiplexes an ordinary packet output from the Ethernet INF unit 216#i and a switching-dedicated packet output from the switching-dedicated packet inserter 214#i, and outputs the multiplexed packets to the Ethernet/SDH converter 222#i.

The Ethernet/SDH converter 222#i accommodates the packets in an SDH frame, and outputs the SDH frame to the cross-connect function unit 224#i. The cross-connect function unit 224#i outputs the SDH frame to either one of the SDH INF units 226W#i, 226P#i. The SDH INF units 226W#i, 226P#i output the SDH frame to the transmission path.

The SDH INF units 230W#i, 230P#i receive the SDH frame from the transmission path, and output the SDH frame to the cross-connect function unit 232#i. The cross-connect function unit 232#i receives the SDH frame from either one of the SDH INF units 230W#i, 230P#i, and outputs the SDH frame to the SDH/Ethernet converter 234#i. The SDH/Ethernet converter 234#i assembles an etherpacket from the data accommodated in the SDH frame, and outputs the etherpacket to the switching-dedicated packet detector 236#i.

The switching-dedicated packet detector 236#i has the following functions: (1) The switching-dedicated packet detector 236#i determines whether the station of its own is a relay station or a directly controlled station based on the second setting information stored in the setting information storage unit 212#i. (a) If the station of its own is a relay station, then the switching-dedicated packet detector 236#i outputs the etherpacket to the Ethernet INF unit 238#i. (b) If the station of its own is a directly controlled station, then the switching-dedicated packet detector 236#i compares the first setting information stored in the setting information storage unit 212#i with the network address of the etherpacket. If they agree with each other, then the switching-dedicated packet detector 236#i determines that the etherpacket is a switching-dedicated packet. If they do not agree with each other, then the switching-dedicated packet detector 236#i determines that the etherpacket is an ordinary packet. If etherpacket is a switching-dedicated packet, then the switching-dedicated packet detector 236#i extracts a link state of the switching-dedicated packet. If the link state represents a link failure, the switching-dedicated packet detector 236#i notifies the link break controller 240#i of the link failure. At this time, the switching-dedicated packet detector 236#i immediately notifies the link break controller 240#i of the link failure without waiting for a flapping prevention protection time to elapse. Since the switching-dedicated packet is recognized when the network address of the etherpacket agrees with a particular value and each of the SA and the DA is of 64 bits and long, it is not necessary to take into account flapping prevention by setting the particular value to a value which cannot agree with the network address when it is indefinite due to USPR. Specifically, a packet that is determined as a switching-dedicated packet can be determined as being normal, free of the effect of flapping due to UPSR.

The Ethernet INF unit 238#i sends the packet output from the switching-dedicated packet detector 236#i to the transmission path. When the link break controller 240#i is notified of a link break by the switching-dedicated packet detector 236#i, the link break controller 240#i indicates the link break according to a given protocol.

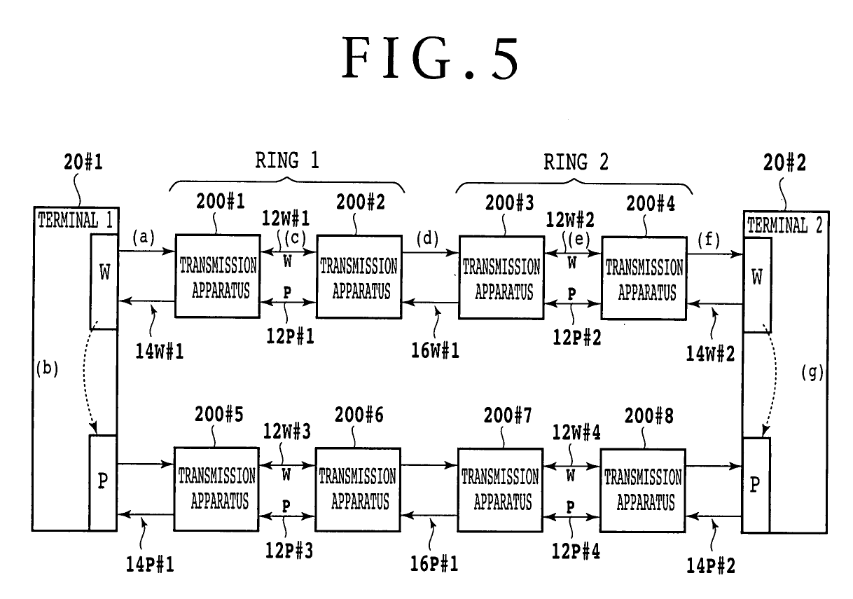

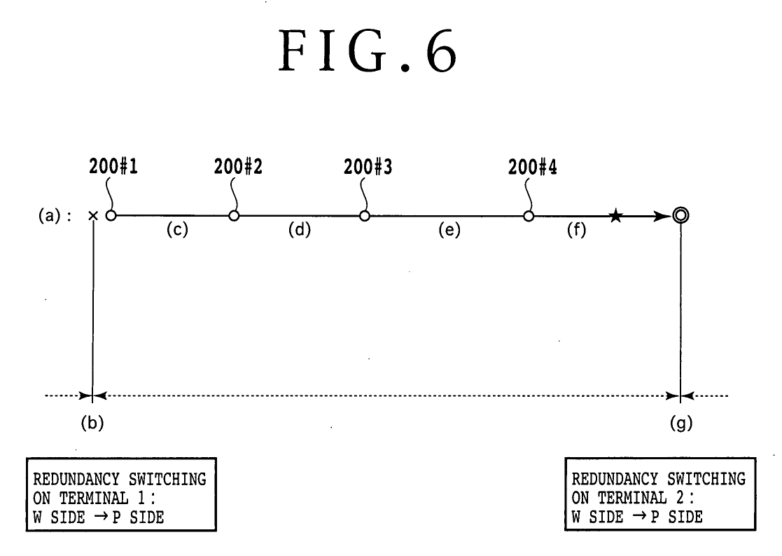

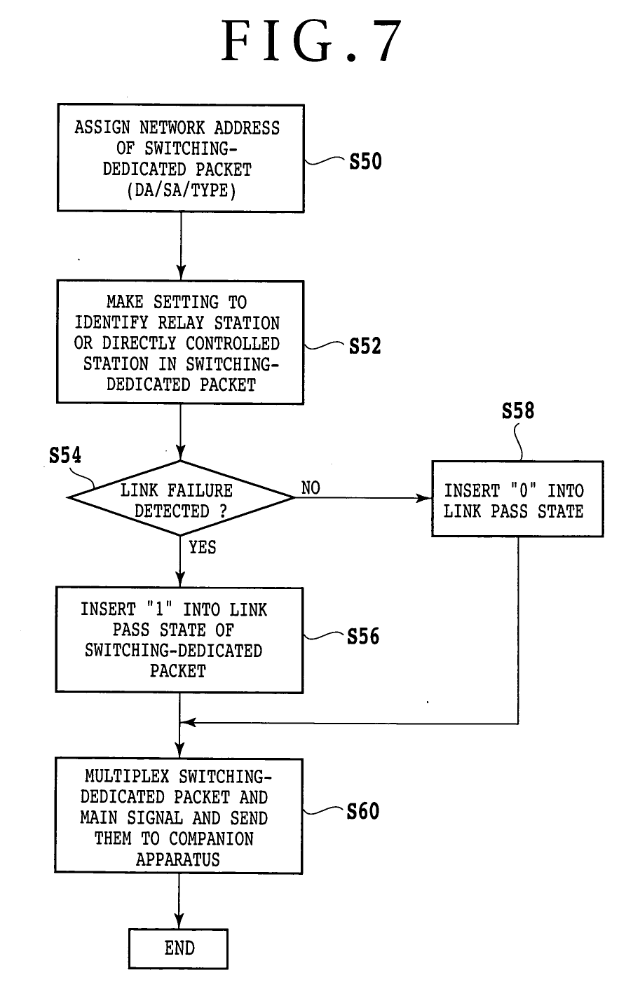

Operation of the transmission system shown in FIG. 2 will be described below. FIGS. 5 and 6 are diagrams illustrative of operation of the transmission system shown in FIG. 2, and show a switching control process at the time the transmission path 14W#1 of the active system between the terminal 20#1 and the transmission apparatus 200#1 fails. FIG. 7 is a flowchart of an operation sequence for sending a switching-dedicated packet.

As indicated at (a) in FIG. 5 and (a) in FIG. 6, the terminal 20#1 and the transmission apparatus 200#1 detect a link break in the transmission path 14W#l. When the terminal 20#1 detects the link break, it switches to the Ethernet INF unit 30P#1 of the inactive system as indicated at (b) in FIG. 5 and (b) in FIG. 6. In step S50 shown in FIG. 7, the OPS 202 sets the first setting information in the transmission apparatus 200#1. In step S52, the OPS 202 sets the second setting information in the transmission apparatus 200#1 as a directly controlled station. In step S54, the transmission apparatus 200#1 determines whether a link failure is detected or not. If a link failure is detected, then control goes to step S56. If a link failure is not detected, then control goes to step S58.

In step S56, the transmission apparatus 200#1 sets the first setting information in the header of a switching-dedicated packet, and inserts “1” indicative of the link failure into the link pass state of the data field. In step S58, the transmission apparatus 200#1 sets the first setting information in the header of a switching-dedicated packet, and inserts “0” indicative of the normal link into the link pass state of the data field. In step S60, the transmission apparatus 200#1 multiplexes the switching-dedicated packet and a main signal (ordinary packet) in the payload of an SDH frame, and sends the SDH frame to the transmission apparatus 200#2 as a companion apparatus, as indicated at (c) in FIG. 5 and (c) in FIG. 6.

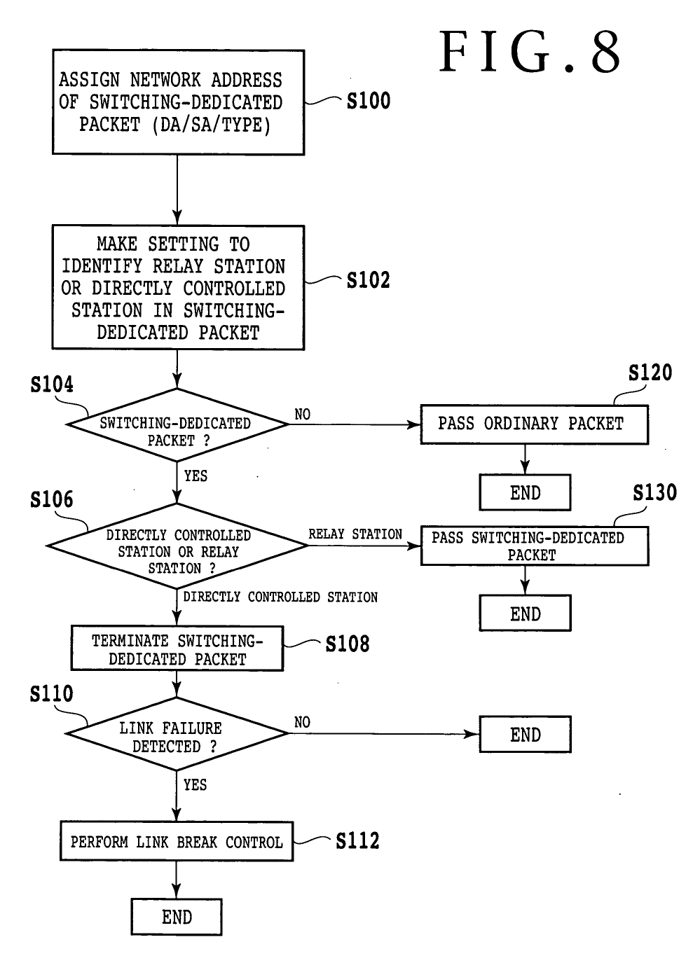

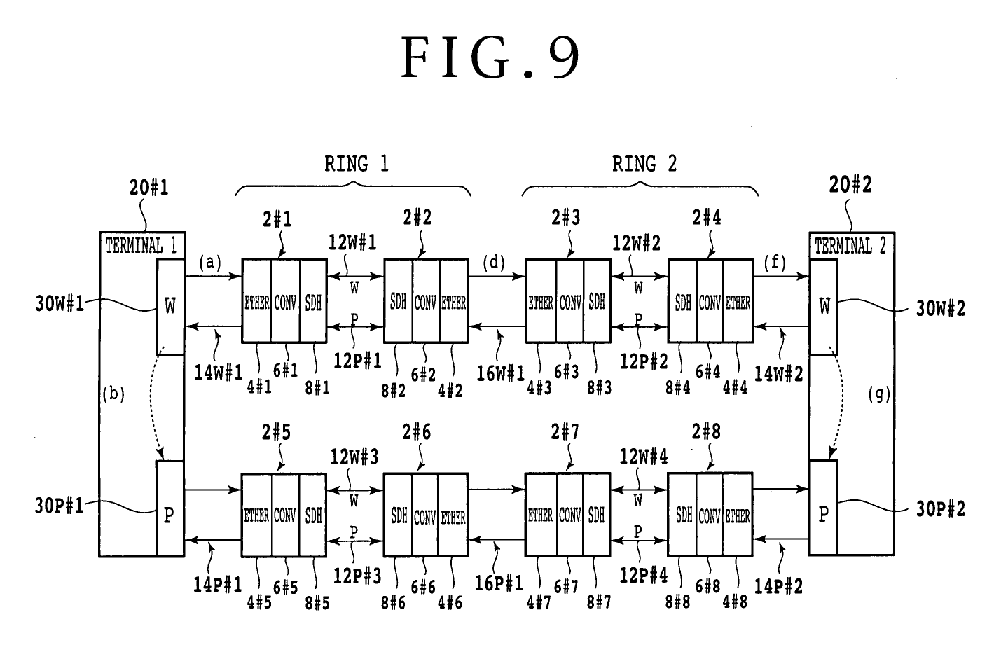

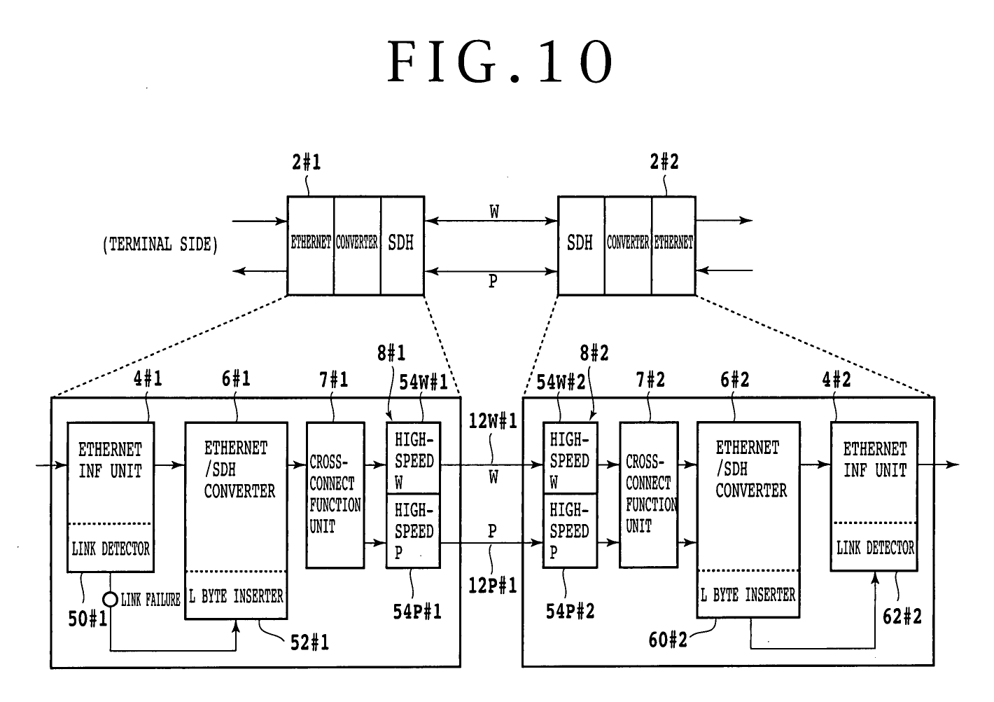

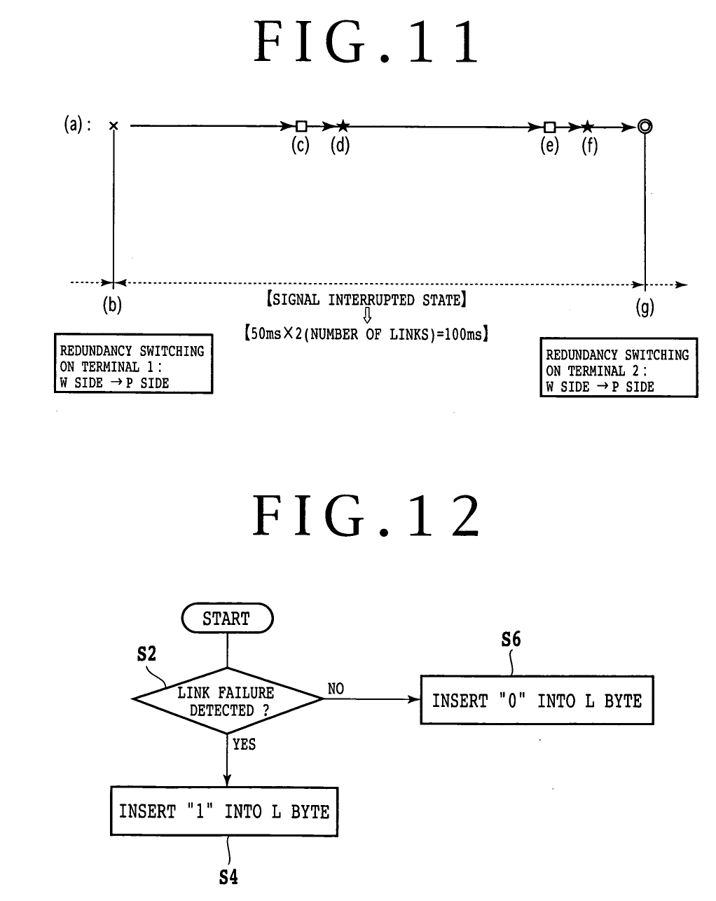

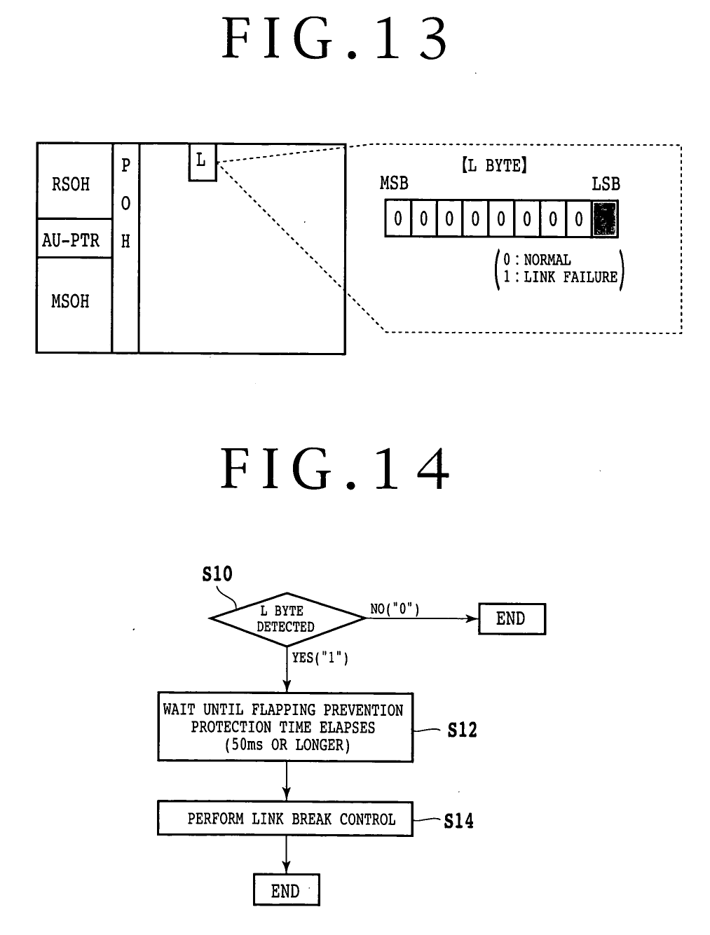

In step S100 shown in FIG. 8, the OPS 202 sets the first setting information (network address) in the transmission apparatus 200#2, 200#3. In step S102, OPS 202 sets the second setting information in the transmission apparatus 200#2, 200#3 as relay stations. The transmission apparatus 200#2 converts the SDH frame received from the transmission apparatus 200#1 into a packet. In step S104, the transmission apparatus 200#2 compares the first setting information and the network address of the received packet with each other to determine whether the received packet is a switching-dedicated packet or not. If the received packet is a switching-dedicated packet, then control goes to step S106. If the received packet is not a switching-dedicated packet, control goes to step S120.

In step S106, the transmission apparatus 200#2 determines whether the station of its own is a directly controlled station or a relay station. If the station of its own is a directly controlled station, then control goes to step S108. If the station of its own is a relay station, then control goes to step S130. Since the transmission apparatus 200#2 is a relay station, control goes to step S130. In step S130, the transmission apparatus 200#2 passes the switching-dedicated packet, accommodates the switching-dedicated packet in an SDH frame, and sends the SDH frame to the transmission apparatus 200#3 as a companion apparatus as indicated at (d) in FIG. 5 and (d) in FIG. 6.

When the transmission apparatus 200#3 receives the packet from the transmission apparatus 200#2, the transmission apparatus 200#3 determines whether the received packet is an ordinary packet or a switching-dedicated packet in step S104 shown in FIG. 8. If the received packet is an ordinary packet, then the transmission apparatus 200#3 accommodates the ordinary packet in an SDH frame and sends the SDH frame to the transmission apparatus 200#4 as a companion apparatus in step S120. Since the transmission apparatus 200#3 is a relay station, the transmission apparatus 200#3 accommodates the switching-dedicated packet in an SDH frame, and sends the SDH frame to the transmission apparatus 200#4 as a companion apparatus in step S130, as indicated at (e) in FIG. 5 and (e) in FIG. 6.

In step S100 shown in FIG. 8, the OPS 202 sets the first setting information in the transmission apparatus 200#4. In step S102, OPS 202 sets the second setting information in the transmission apparatus 200#4 as a directly controlled station. The transmission apparatus 200#4 converts the SDH frame received from the transmission apparatus 200#3 into a packet. The transmission apparatus 200#4 determines whether the received packet is an ordinary packet or a switching-dedicated packet. If the received packet is an ordinary packet, then the transmission apparatus 200#4 sends the ordinary packet to the transmission apparatus 200#2 as a companion apparatus in step S120.

In step S106, the transmission apparatus 200#4 determines whether the station of its own is a directly controlled station or a relay station. If the station of its own is a directly controlled station, then control goes to step S108. If the station of its own is a relay station, then control goes to step S130. Since the transmission apparatus 200#4 is a directly controlled station, control goes to step S108. In step S108, the transmission apparatus 200#4 terminates the switching-dedicated packet, i.e., does not relay the switching-dedicated packet. In step S110, the transmission apparatus 200#4 determines whether a link failure is detected or not from the link state set in the switching-dedicated packet. If a link failure is detected, then control goes to step S112. Since a link failure is detected in this case, then control goes to step S112. If a link failure is not detected, then the operation sequence is put to an end.

The transmission apparatus 200#4 carries out a link break control process, e.g., interrupts a signal transmitted to the transmission path 14W#2, to notify the terminal 20#2 of the link break, as indicated at (f) in FIG. 5 and (f) in FIG. 6. If the transmission apparatus 200#4 has a plurality of Ethernet INF units for sending packets to the terminal 20#2, then the transmission apparatus 200#4 performs a link break control process through one of the Ethernet INF units which corresponds to the location of the link failure which is set in the link pass information of the switching-dedicated packet.

When the terminal 20#2 receives the notification of the link break from the transmission apparatus 200#4, the terminal 20#2 switches from the Ethernet INF unit 30W#2 to the Ethernet INF unit 30P#2. In this manner, communications via the transmission apparatus 200#5 through 200#8 are selected between the terminal 20#1 and the terminal 20#2. At this time, since the switching-dedicated packet is relayed and the link break is indicated without the elapse of a flapping prevention protection time, as shown in FIG. 6, the terminal 20#2 is immediately notified of the link break, and the switching is performed at a high speed.

If the transmission path 14W#2 between the transmission apparatus 200#4 and the terminal 20#2 suffers a link break due to a failure, then the transmission apparatus 200#4 generates a switching-dedicated packet, and transfers the switching-dedicated packet from the transmission apparatus 200#3 to the transmission apparatus 200#2 to the transmission apparatus 200#1, which performs a link break control process.

If the transmission path 16W#1 between the transmission apparatus 200#2 and the transmission apparatus 200#3 suffers a link break due to a failure, then a link break control process is performed as follows: The transmission apparatus 200#2, 200#3 generate switching-dedicated packets. The switching-dedicated packet generated by the transmission apparatus 200#2 is transferred to the transmission apparatus 200#1, which performs a link break control process. The switching-dedicated packet generated by the transmission apparatus 200#3 is transferred to the transmission apparatus 200#4, which performs a link break control process.

According to the present embodiment, if a link break is set in a switching-dedicated packet, a directly controlled station immediately performs a link break control process without waiting for a flapping prevention protection time to elapse. However, even when a switching-dedicated packet is recognized, if the possibility of the link state of a link break set in the switching-dedicated packet due to UPSR is low, but a flapping prevention protection time needs to elapse, then only a directly controlled station may perform a link break control process after having waited for the flapping prevention protection time to elapse. In this case, only the directly controlled station waits for the flapping prevention protection time to elapse regardless of the number of links, and a relay station relays the switching-dedicated packet without waiting for the flapping prevention protection time to elapse. Therefore, the link break control process can be performed on the terminal 20#2 for high-speed switching. Even in this case, since a network which is free of a redundancy configuration based on a ring network does not suffer flapping due to UPSR, a directly controlled station performs a link break control process without waiting for a flapping prevention protection time to elapse. In this case, the OPS 202 may set a method of a switching process, e.g., UPSR or a single system without switching, as third setting information other than the first and second setting information, in the directly controlled station, and store the method of the switching process in the setting information storage unit 212#i. If the third setting information represents UPSR, then the directly controlled station may perform a link break control process when the switching-dedicated packet represents a link failure after elapse of a flapping prevention protection time depending on the switching process. If the third setting information represents a single system without switching, then the directly controlled station may immediately perform a link break control process without waiting for a flapping prevention protection time to elapse.

As described above, a switching-dedicate packet is provided and new functions are added to allow a high-speed link pass-through process to be carried out for shortening a signal interruption time during the switching time. The present invention is applicable to existing infrastructures easily in terms of cost without substantially changing the conventional network configuration.

The present invention is not limited to the details of the above described preferred embodiments. The scope of the invention is defined by the appended claims and all changes and modifications as fall within the equivalence of the scope of the claims are therefore to be embraced by the invention.

What is claimed is:

1. A transmission apparatus comprising:
a LAN interface for sending and receiving an ordinary packet to and from a first transmission path according to a LAN interface process;
a synchronous frame interface for sending and receiving a synchronous frame to and from a second transmission path;
a link detector for detecting a physical link failure of said first transmission path;
a first setting information storage unit for storing first setting information for distinguishing between a switching-dedicated packet and an ordinary packet, said first setting information being set in a header of said switching-dedicated packet;
a switching-dedicated packet inserter for setting a link pass state indicative of whether said physical link failure is normal or abnormal as detected by said link detector, and said first setting information in the header of said switching-dedicated packet;
a packet multiplexer for multiplexing said switching-dedicated packet and said ordinary packet;
a packet/synchronous frame converter for accommodating the multiplexed packets in said synchronous frame; and
a synchronous frame/packet converter for converting the synchronous frame received by said synchronous frame interface into a packet.

2. The transmission apparatus according to claim 1, further comprising a switching-dedicated packet detector for comparing said first setting information and the packet converted by said synchronous frame/packet converter with each other to determine whether the packet is a switching-dedicated packet sent from a companion transmission apparatus or not, and outputting the packet to said LAN interface if the packet is an ordinary packet, and a link break controller for performing a link break control process on said first transmission path if the link pass state set in the switching-dedicated packet detected by said switching-dedicated packet detector represents a link failure.

3. The transmission apparatus according to claim 2, further comprising a second setting information storage unit for storing second setting information representative of a directly controlled station having a terminal connected to said first transmission path or a relay station having no terminal connected to said first transmission path, wherein said switching-dedicated packet detector transfers said switching-dedicated packet to said LAN interface when a station of its own represents said relay station based on said second setting information, said switching-dedicated packet detector notifies said link break controller of the link failure when the station of its own represents said relay station based on said second setting information and said link pass state of the switching-dedicated packet represents said link failure, and said link break controller performs said link break control process based on the link failure indicated by said switching-dedicated packet detector.

4. The transmission apparatus according to claim 3, wherein said link break control process is immediately performed when the switching-dedicated packet with the link failure set therein is detected by said switching-dedicated packet detector.

5. The transmission apparatus according to claim 2, wherein said synchronous frame interface has a redundancy configuration, said transmission apparatus having a function to perform switching on said synchronous frame interface of the redundancy configuration.

6. The transmission apparatus according to claim 2, wherein said first setting information includes a destination address, a source address, and a type value of an etherpacket header.

7. The transmission apparatus according to claim 2, wherein said LAN interface comprises a plurality of LAN interfaces for receiving a LAN packet, and said switching-dedicated packet detector includes transmission path information representing a link failure in said first transmission path connected to said LAN interfaces.

8. The transmission apparatus according to claim 7, wherein said LAN interface comprises a plurality of LAN interfaces for sending a LAN packet, said link break controller comprises a plurality of link break controllers, and said switching-dedicated packet detector notifies one of the link break controllers which corresponds to the transmission path information representing a link failure, of said link failure.

9. A transmission system comprising a first transmission apparatus connected to a first terminal, a second transmission apparatus connected to said first transmission apparatus, a third transmission apparatus connected to said second transmission apparatus, and a fourth transmission apparatus connected to said third transmission apparatus, comprising:
LAN interfaces provided respectively in said first through fourth transmission apparatus, for sending and receiving an ordinary packet according to a LAN interface process;
synchronous frame interfaces provided respectively in said first through fourth transmission apparatus, for sending and receiving a synchronous frame;
a link detector provided in said first transmission apparatus for detecting a physical link failure of a transmission path connected to said first terminal;
a first setting information storage unit provided in said first and second transmission apparatus for storing first setting information for distinguishing between a switching-dedicated packet and an ordinary packet, said first setting information being set in a header of said switching-dedicated packet;
a switching-dedicated packet inserter provided in said first transmission apparatus for setting a link pass state indicative of whether said physical link failure is normal or abnormal as detected by said link detector, and said first setting information in the header of said switching-dedicated packet;
a packet multiplexer provided in said first transmission apparatus for multiplexing said switching-dedicated packet and said ordinary packet;
a packet/synchronous frame converter provided in said first transmission apparatus for accommodating the multiplexed packets in said synchronous frame;
packet/synchronous frame converters provided in said second through fourth transmission apparatus for accommodating the packet received by said LAN interfaces in said synchronous frame;
synchronous frame/packet converters provided in said first through fourth transmission apparatus for converting the synchronous frame received by said synchronous frame interface into a packet;
second setting information storage units provided in said second through fourth transmission apparatus for storing second setting information representative of a directly controlled station having a terminal connected to transmission paths to which said LAN interfaces are connected or a relay station having no terminal connected to said transmission paths;
switching-dedicated packet detectors provided in said second and third transmission apparatus for comparing said first setting information and a header of the packet converted by said synchronous frame/packet converters with each other to determine whether the packet is a switching-dedicated packet sent from a companion transmission apparatus or not, outputting the ordinary packet to said LAN interfaces, transferring said switching-dedicated packet to said LAN interfaces when a station of its own represents said relay station based on said second setting information, and indicating a link failure when the station of its own represents said directly controlled station based on said second setting information and said link pass state of said switching-dedicated packet represents said link failure; and
a link break controller provided in said third transmission apparatus for performing a link break control process based on the link failure indicated by said switching-dedicated packet detectors.

10. The transmission system according to claim 9, wherein said synchronous frame interfaces of said first and second transmission apparatus have a redundancy configuration, said first and second transmission apparatus serving as a first ring network having a function to perform switching on said synchronous frame interfaces of the redundancy configuration, and wherein said synchronous frame interfaces of said third and fourth transmission apparatus have a redundancy configuration, said third and fourth transmission apparatus serving as a second ring network having a function to perform switching on said synchronous frame interfaces of the redundancy configuration.
